(19) United States
(12) Patent Application Publication
(10) Pub. No.: US 2004/0222158 A1
(43) Pub. Date: Nov. 11, 2004

(54) Nanofiltration system for water softening with internally staged spiral wound modules

(76) Inventors: Hidayat Husain, Brampton (CA); Pierre Lucien Cote, Dundas (CA); Fraser Charles Kent, Milton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/798,310

(22) Filed: Mar. 12, 2004

Related U.S. Application Data
(60) Provisional application No. 60/454,341, filed on Mar. 14, 2003.

(51) Int. Cl. B01D 61/00

(52) U.S. Cl. 210/651; 210/650; 210/321.74; 210/321.83

(57) ABSTRACT

A spiral wound membrane filtration module is operated with a single pass through the feed side and without cross-flow on the permeate side. Recovery is 70% or more and feed side velocities are between 0.05 and 0.4 feet per second. The module may have dams in the spacer material on the shell/feed side to provide a feed path with multiple passes across the membrane leaves. A small-scale system for using such a module, for example to soften and filter water with a nanofiltration membrane, is described. The system includes a chemical cleaning apparatus and process.

This patent claims the benefit under 35 USC 119(e) of U.S. provisional application No. 60/454,341, filed Mar. 14, 2003, which is incorporated herein in full by this reference to it.

### FIELD OF THE INVENTION

This invention relates to a water softening process or apparatus, to a membrane filtration system, such as by reverse osmosis (RO), nanofiltration (NF) or ultrafiltration (UF), and to a method and system for treating home, multi-residential, commercial, institutional or industrial water to remove one or more of hardness, heavy metals, natural organic matter, particulate matter, pathogens or other impurities.

### BACKGROUND OF THE INVENTION

Currently, ion exchange based water softening is the most common method for reducing water hardness in homes and small applications. These methods have many disadvantages, including the addition of sodium to water, discharge of sodium chloride laden waste streams, and ineffective removal of heavy metals, arsenic and other impurities. Also, these systems have very little effectiveness for removing pathogens such as E-coli, Crptosporidium parvum, and Giardia lambia.

RO and NF systems are also used for water softening on a small scale, and provide effective treatment for removal of hardness and other impurities. However, these systems generally use a single module. A key limitation of these systems is the need to recycle concentrate to maintain high velocities across the membrane surface to avoid fouling. This results in high cost. These RO/NF small systems also incorporate complex cleaning methods, and the systems are operated at low recovery to delay cleaning, resulting in water wastage.

In U.S. Pat. No. 4,814,079, a spiral wound RO membrane cell was modified by removing the spacer material and replacing it with strips of impermeable material to define a convoluted open feed flow path between envelopes of semipermeable membrane sheets. The convoluted flow path allowed the minimum velocity of feed flow to be increased to 3 to 10 feet per second at feed flow rates that would result in feed flow velocity of 1.3 feet per second in an unmodified module. The increased speed of feed flow and absence of spacer material was said to improve operation in water with high solids concentrations, which is fed to the module without pre-filtration. In a preferred configuration, the strips of impermeable material are arranged perpendicular to a central mandrel so that strips of one envelope bear on strips of another envelope when the module is wound. This is taught to avoid problems, for example that the strips of one envelope would push into the feed channels of adjacent envelopes, that would occur if the strips were laid out parallel with the mandrel.

### SUMMARY OF THE INVENTION

It is an object of the present invention or inventions to improve on the prior art. Other objects of the invention include providing a water softening process or apparatus, providing a membrane filtration process or apparatus, for example in one or more of the RO, NF or UF ranges, and providing a method of cleaning the membranes in such systems, for example for home, multi-residential, commercial, institutional or industrial applications. The one or more inventions consist of combinations of one or more of the elements or steps described in this document. The summary below discusses various features of the one or more inventions that may be help the reader understand the one or more inventions, but is not intended to define any invention.

In some aspects, the invention provides a membrane filtration system having a spiral wound reverse osmosis, nanofiltration or ultrafiltration module. The modules has a feed/concentrate side and a permeate side and is contained in a pressure housing or shell. The system also includes a feed water pump, a permeate receiving or holding tank, a chemical cleaning system, conduits for transporting feed, permeate and concentrate, and a control system apparatus to maintain the desired permeate, concentrate and feed flow. The feed/concentrate side may be the shell side of the module and operate with feed flowing through it in a single pass, all non-permeated feed exiting the shell as concentrate or retentate. The permeate side may be the mandrel side and operate with one or more permeate outlets only, that is without cross-flow on the permeate side between an inlet and an outlet. Feed, for example from a well, surface or municipal water source, enters at supply pressure to the inlet side of the feed pump. Where the feed supply uses a pump, the feed supply pump and filtration system pump may be combined. The pressurized feed from the pump is fed to the filtration module. A permeate stream is recovered through a permeate manifold, and a concentrate stream is collected through a concentrate manifold. Relative to the feed, the permeate has a decreased concentration of impurities, such as hardness, while the concentrate side has an increased concentration. The permeate is stored in the holding tank which may be a diaphragm tank that holds the permeate under pressure so as to supply permeate to the user without further pressurization. Concentrate is sent to drain or removed from the system for other processing. The chemical cleaning system is operated from time to time to increase permeability of the module. The module may be a modified module as described below.

In other aspects, the invention provides a spiral wound filtration module (which may be called an internally staged module) wherein the feed follows a flow path that makes multiple passes (each pass may also be called a stage) across the length or width of the envelopes (which may also be called leaves) of the module. For example, there may be between 3 and 9, or between 5 and 7, passes. The flow path may be through the spacer material between leaves on the shell side of the module. The passes may have edges defined by dams (which may also be called baffles or dividers) through or between areas of spacer material. The passes may have a declining width or cross-sectional area, within a pass or as between passes or both, such that there may be a substantially constant or increasing velocity through the feed/concentrate side of the module under suitable operating conditions, such as operating conditions described in this document. For example, the width or cross-sectional area of the end of the last stage may be about 20% or less or 15% or less than the width or cross-sectional area of the beginning of the first stage. The passes may be generally parallel with a central mandrel, i.e. extending back and forth across the length of the module, and the first pass may be more distant from the mandrel than the last pass. The module may have membrane material with pores in one or more of the UF, NF or RO ranges. For water softening applications, the pore size and membrane material may be specified as having hardness rejection of 50% or more and may provide 30% or more or 50% or more rejection of hardness operating in a system.

In other aspects, the invention relates to a process for operating a membrane filter, for example a membrane filter as described above, in a system, for example a system as described above. For further example, the module may be an NF module used to remove hardness and other impurities from feed water in a small-scale system. In the process, feed passes through the feed side (alternately called the feed/concentrate side) of the module in a single pass. The minimum superficial feed side velocity or the superficial exit velocity of the module is at least 0.05 ft/second, preferably above 0.12 ft/s. For example the minimum superficial feed side velocity or the superficial exit velocity may be between 0.05 and 0.4 feet per second or between 0.12 and 0.3 feet per second. Superficial velocities are defined as the velocity assuming that the feed/concentrate side spacer does not have a volume and are meant in this document unless stated otherwise. Velocity may increase as the feed travels through the module. For example, an exit velocity, measured at the end of a last stage, may be about 1.2 times or more than the average velocity in a first stage. The permeate side may receive permeate only through the membrane and release permeate from an outlet, that is without cross flow between an inlet and outlet. The amount of permeate recovered is 70% or more, alternately 80% or more or in the range of 80 to 95% of the amount of feed entering the module. Pressure drop through the feed side is kept within tolerable limits for the module. For example, the feed side pressure drop may be 10 psi or less or 5 psi or less.

In other aspects, the invention provides a means of chemical cleaning a membrane module. The chemical cleaning may occur on a regular basis, particularly during periods of low use, or when membrane fouling is indicated by process conditions, optionally using a timer or controller to perform or assist in indicating when cleaning is required or to perform some or all of the cleaning steps. The cleaning system may consist of a chemical solution tank, a venturi feeder in the feed line, valves to direct feed water flow through the venturi and feed side of the module, a valve on the permeate side to flush out the cleaning solution after cleaning and, optionally, a controller or a timer. Alternately, the cleaning system may include a chemical tank arranged to flow cleaning chemicals through the feed side of the module by gravity, optionally in a direction reverse to normal flow. The chemical is allowed to react with foulants for a period of time and then flushed from the module or system, or it may be allowed to stand in the system until the system is activated due to water demand. Chemical cleaning may be provided frequently, for example between once a day and once a month, to keep the permeability of the membranes near, for example within 25% of their maximum permeability, for extended periods, for example a year or more. Alternately, chemical cleaning may be provided less frequently, for example not more than once or twice a year, in a system and process designed to have a low fouling rate or to tolerate larger variations in membrane permeability or both.

In other aspects, the invention provides a means of producing an internally staged spiral wound module. One method involves installing dams made from silicon, hot melt or any other thermoplastic material on the module spacer in a pattern that produces the internal stages, inserting the spacer between the leaves and then rolling the module. Alternately, the dams may be installed on the membrane surface, using a suitable material, and the spacer material provided between the dams. Further alternately, a custom spacer may be made incorporating dams. Further alternately, the dams may be made as strips of thermoplastic materials, to be placed on both sides of a spacer during the assembly process.

In other aspects, the invention relates to a system that may be used for: removing pathogens, particulate matter or organic matter naturally present in water, for both softening and desalting, or softening or desalting only, by selecting a suitable membrane material. A process, module or system as described above may be used. A chemical cleaning solution may be selected to dissolve impurities that may deposit on the membrane as a result of desalting.

In another aspect, the dissolved oxygen content or oxygen reduction potential of the feed water is modified upstream of the membrane filter to enhance filterability. In another aspect, a single spiral wound module has multiple leaves of membrane material and at least one leaf has a different membrane material or chemistry than another leaf. In another aspect, a filtration system is operated intermittently to provide rest periods for the membranes between permeation periods. Other aspects of the invention may be described by the claims.

An exemplary small-scale water softening and filtration system uses one or more of the aspects of the invention described above to advantage. The module is made from a commercially available spiral wound nanofiltration module easily and inexpensively modified to provide multiple passes through the feed side spacer. The spacer creates turbulence that assists in keeping the fouling rate low despite the low feed side velocities. The low feed velocities, combined with the multiple pass feed flow, permits the high single pass recovery without elevating the pressure drop beyond the limits on an inexpensive module. The multiple passes also make recoveries of 70% or higher possible using standard module construction despite the low permeability (for example less than 0.3 gfd/psi for Filmtec NF-270) of currently available RO and NF membranes. Current NF or RO hardness rejecting membrane materials in standard 8040 modules (8″ diameter, 40″ length) do not allow 70% recovery with at least 0.05 feet per second exit velocity in a single pass without staging since a permeability of about 0.6 gfd/psi would be required. The single pass, high recovery operation in turn allows for a simplified system without recirculation equipment but with reasonable concentrate discharge rates. Fouling rates are low enough that simplified chemical cleaning processes and apparatus are sufficient. The complete system can be made suitable in cost and operational complexity for use even at the level of an individual household. These same advantages can also be used in other or modified systems, for example small scale ultrafiltration or reverse osmosis systems designed to remove a variety of impurities from feed water. In an ultrafiltration system, membrane permeability may be sufficient to operate standard 40″ spiral wound modules without internal staging according to a system or process as described in this patent.

### BRIEF DESCRIPTION OF THE FIGURES

Exemplary embodiments or one or more inventions will be described below with reference to the following Figures.

FIG. 1 is a schematic representation of a system.

FIG. 2 is a schematic representation of another system.

FIG. 3 is a photograph of a section of an internally staged module.

FIG. 4 is a drawing of the feed side spacer of another module.

FIG. 5 is a graph of experimental data.

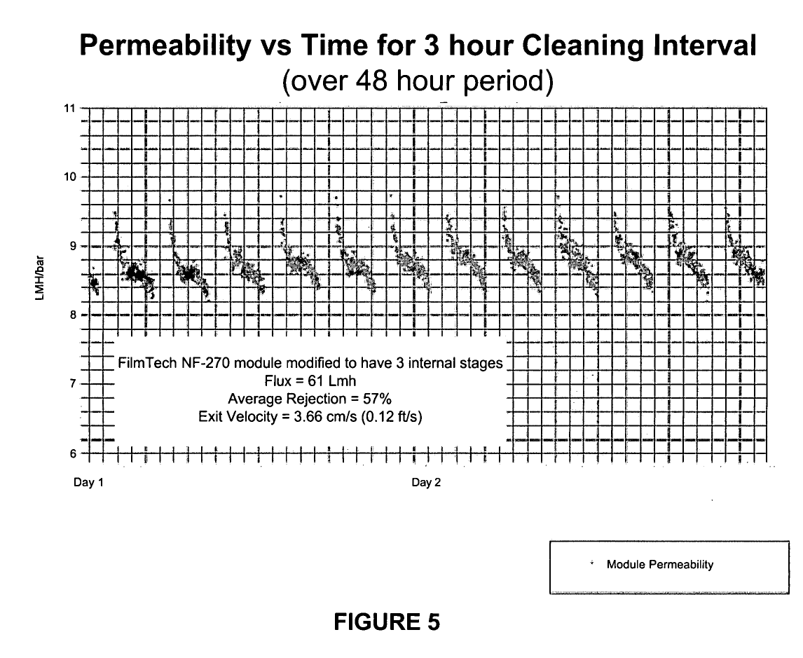

### DETAILED DESCRIPTION OF ONE OR MORE EXEMPLARY EMBODIMENTS

Systems

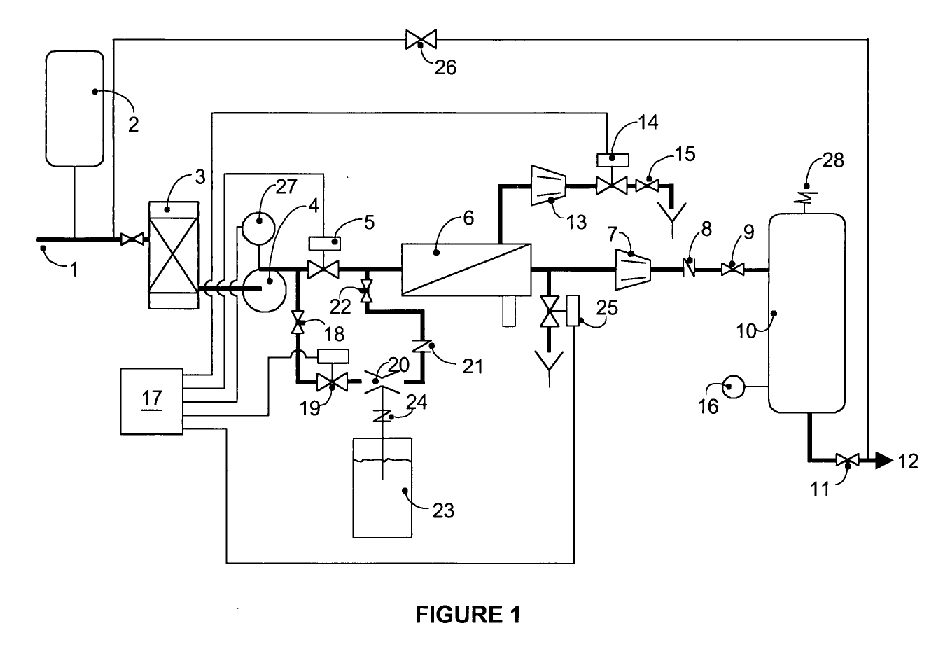

FIG. 1 shows a reactor for softening, desalting or filtering water. Water 1, for example from municipal, well or surface water supply, or from an existing feed tank 2 may be filtered through a cartridge filter 3 and is then fed to the feed side of a pump 4. An activated carbon filter may be used instead of a cartridge filter if the feed water contains chlorine or hydrogen sulphide gas. The pump raises the pressure of the water by 50 to 200 psi, for example by about 100 psi, and introduces it to an internally staged nanofiltration or reverse osmosis module 6. The module 6 may be a module as described further below and contain as low as 3 and as high as 9 stages or passes on the feed side. More than nine stages are possible, but would likely require a reduction in the number of membrane sheets and an increase in the width of the sheet to provide sufficient width for practical stage design and construction which may preclude simply modifying a standard module. In an ultrafiltration system, a module 6 with sufficient permeability, for example about 0.6 gfd/psi or more, may be useable in a system as described in this patent without internal staging. For example, a Celguard WQ123704 module has permeability, at a TMP of 30-100 psi, of between 0.59 and 0.82 gfd/psi and has 5 kDalton rejection. While not hardness rejecting, such a module provides tight ultrafiltration and removes, for example, natural organics.

In the module 6, clean permeate is separated from the concentrate, and flows through a check valve 8 and a manual valve 9 to an air-pressurized diaphragm tank 10 where it is stored under pressure suitable for supply to the user 12 through a manual valve 11. The concentrate is discharged through a variable area orifice flow controller 13, a solenoid valve 14 and a manual valve 15 to drain. Variable area orifice flow controllers 7 and 13 are set to provide the desired recovery of purified water of 50-95% of feed water, preferably in the range of 70-95% or 80-90% of feed water. Controller 7 allows recovery rates to be kept nearly constant but also increases head loss on the permeate side and may be deleted, particularly for small or home systems.

When the pressure in the diaphragm tank 10 reaches a preset maximum, a pressure switch 16 shuts down pump 4 and closes solenoid valve 14 to stop the permeate production process cycle. Although not essential, in some cases it may be advantageous to use a delay switch (not shown in FIG. 1) to delay closing of the valve 14 for 5-10 seconds to flush out the concentrate from the membrane. Conversely, pressure switch 16 starts the process cycle by switching pump 4 and valve 14 on when the diaphragm tank 10 pressure drops below a pre-set value. Values of the upper and lower pressure limits depend on the line 12 supply requirements, but may be in the range of 30 and 60 psi for a home. Alternately, the pump 4 and valve 14 may be turned on and off in response to the water level in a holding or diaphragm tank as sensed by a water level or pressure sensor.

At a pre-set time, or if a high pressure is indicated by a high/low pressure indicator 27, a controller 17 initiates a cleaning cycle. In this way, cleaning is accomplished at a regular interval or when the feed pressure, which is related to a loss in membrane permeability, exceeds a preset value. Solenoid valve 5 is closed and valve 19 is opened to permit the flow of water through normally open manual valve 18, solenoid valve 19, venturi feeder 20 and check valve 21 and normally open manual valve 22 to module 6. Manual valves 18 and 22 are available to isolate the chemical tank 23, for example to clean or re-fill it. At the same time, solenoid valve 14 is left open to permit displacement of fluid in the concentrate channel with the chemical solution. Also, solenoid valve 25 is open to drain any permeate formed during the cleaning cycle. The chemical, contained in tank 23 is sucked up into the water stream through check valve 24 through a pressure drop created in the venturi feeder 20. This operation is continued for a preset time to fill the feed side of the module 6 with chemical solution, but not for so long to waste large amounts of chemical solution through the concentrate or permeate discharge lines. The controller 17 closes valve 19, valve 14 and valve 25 to discontinue cleaning solution feed after a preset time of feeding. Valve 5 may, optionally, also be opened. The water feed during the cleaning solution may ideally be under water supply 1 pressure to reduce permeation through the module 6 and valve 25. Alternately, for cases where the line pressure is less than 40 psi, pump 4 may be used to pressurize the water through the venturi feeder to provide the pressure drop necessary for introducing the chemical solution into the water stream.

The duration of chemical feeding depends on the type of module 6 used, the flow rate of the chemical solution and the system configuration and is calculated as:

Time of chemical feed (minutes)=hold-up volume of system from the venturi feeder 20 to orifice valve 12 in gallons divided by the water flow rate in gallon per minute

After the pre-set chemical feeding time, controller 17 may open valve 5 if it is not already open. Alternately, valve 5 may be closed anytime that pump 4 is not operating to prevent back flow from the tank 10 if there are any leaks in the system. Valves 14, 19 and 25 stay closed while permitting the cleaning chemical to remain in the module 6 until the pressure in tank 10 drops below the pre-set value to start the permeation cycle, which leads to a return to permeation and flushing out of the chemical solution from the concentrate channel. Alternately, the hold time may extend beyond the chemical feed time only by a selected time that may vary from 30 minutes to 5 hours, for example 1-2 hours. In this case, controller 17 is programmed to start a flush cycle at the pre-set time by opening valve 5, valve 25 (to permit flushing out cleaning chemicals that might have permeated) and valve 14 for a period of time before returning the system to a ready and available state for permeation. The time required to flush out the permeate side of the module 6 and depends on the hold up volume of the module 6 and permeation rate. The feed side of the module is similarly flushed out to a drain.

A pressure switch 27 shuts pump 4 off if the pressure exceeds a preset limit to protect the system and module 6 from overpressure. Also, a pressure release valve 28 depressurizes the diaphragm tank 10 if the pressure in this tank exceeds its design limit or the pressure limit of the user 12.

A manual valve 26 provides a bypass to the entire system to ensure water supply to the user 12 in case of system breakdown.

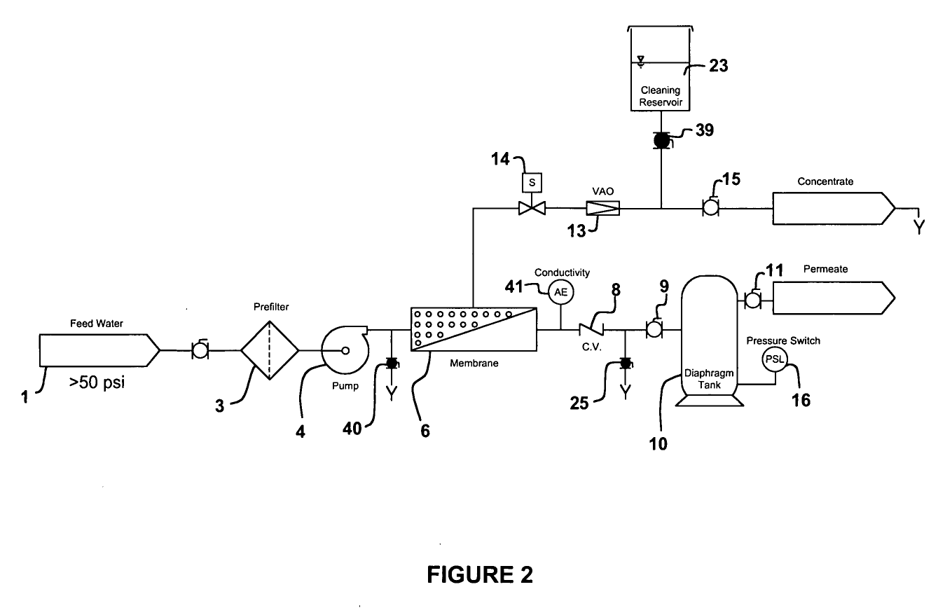

Referring to FIG. 2, a second filtration, softening or desalting system, particularly suited to home application because of its simplicity, is shown. Items with a function similar to those of FIG. 1 are given the same number. The system of FIG. 2 has recovery controlled by a variable area orifice flow controller 13 that keeps the concentrate flow rate nearly constant. However, the system design is based on constant feed pressure which, subject to the pressure variations in the tank 10, gives a generally constant average trans-membrane pressure (TMP) over a period of 6 months or more. By maintaining a constant concentrate flow rate and allowing the flux to decrease as the membrane fouls, the recovery of the system will also decrease with time and lower the concentration of foulants on the feed side with time. This mode of operation requires only the variable area orifice 13 for control of normal operations.

At pre-set times, or in between these times if flux, recovery or pump pressure become unacceptable, the user may implement a manual cleaning operation. In this procedure, a cleaning chemical, such as citric acid or MC-1 (an enhanced citric acid membrane cleaner made by Zenon Environmental Inc.), crystals are added to chemical tank 23. The chemical tank 23 is located directly above the concentrate line just downstream of the variable area orifice 13 that is used for concentrate flow control. Once the crystals have dissolved, the resulting solution is allowed to flow by gravity into the concentrate outlet of the module 6 and through the feed/concentrate side of the module 6 in a direction reversed from normal operation. The cleaning chemical proceeds through to the feed inlet of the module 6 thus filling the feed/concentrate side of the module 6. This is achieved by opening two hand valves 39 and 40. The solution is left to soak for a selected period of time, for example more than 1 hour. The cleaning chemical is then rinsed out of the module by resuming normal operation but optionally permeating to drain for the first few minutes by opening hand valve 25. A conductivity monitor 41 may be provided on the permeate side to monitor membrane integrity.

Module Design

The membrane modules 6 may be a spiral wound module of the type having a central mandrel wrapped in one or more rectangular leaves or envelopes made of membrane material. The mandrel and leaves are contained in a shell. The interior of the leaf contains a spacer material and communicates with holes to the interior of the mandrel. Thus feed applied to the shell side of leaves flows, in part, through the membrane material, travels through the spacer material to the inside of the mandrel and through the mandrel to a permeate outlet. The feed enters the module through a feed inlet on one side of the shell, flows through a second spacer material in between the leaves and out through a concentrate outlet on the other side of the shell.

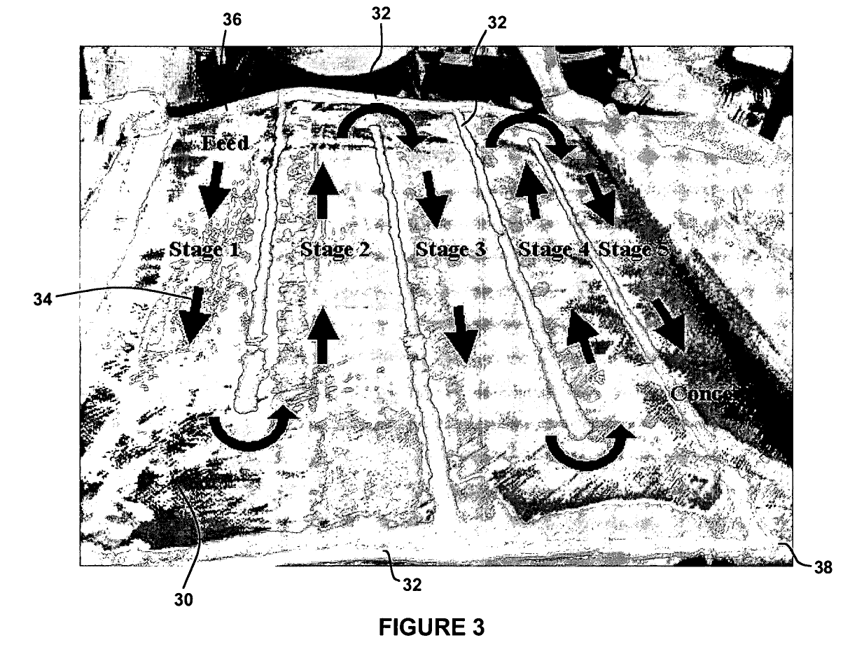

The module 6 may be modified from the description above to create an internally staged module. In particular, as shown in FIG. 3, a feed side spacer 30, for example a mesh such as VEXAR, may be provided with dams 32 to create a flow path 34 that travels back and forth across the spacer 30 between a membrane area inlet 36 to a membrane area outlet 38. The spacer 30 will be placed on one surface of each leaf before the leaves are wound around the mandrel and so will become sandwiched between adjacent leaves. In this way, the feed will travel back and forth across the membrane material of the leaves as the feed follows the flow path 34 through the spacer 30.

The spacers 30 may be modified to provide 2 to 9, typically 3 to 7, stages or passes in the flow path 34. Although other arrangements might be used, the inventors prefer the stages or passes to be parallel to the mandrel. The inventors further prefer the first stage, being the stage adjacent the membrane area inlet 36, to be furthest from the mandrel. Thus, in the embodiment of FIG. 3, stage 5 would be inserted between leaves to lie against the length of the mandrel. In this way, both feed and concentrate flows generally from the distal edge of the leaf to the mandrel resulting in pressure gradients within the leaf and the concentrate channel oriented in the same direction. This helps provide a more even TMP across the stages and more uniform rate of permeation. Flow from the distal edge of the spaces 30 to the mandrel also results in lower feed side pressures near the mandrel where the dams 32 merely but against the mandrel and may not be perfectly sealed.

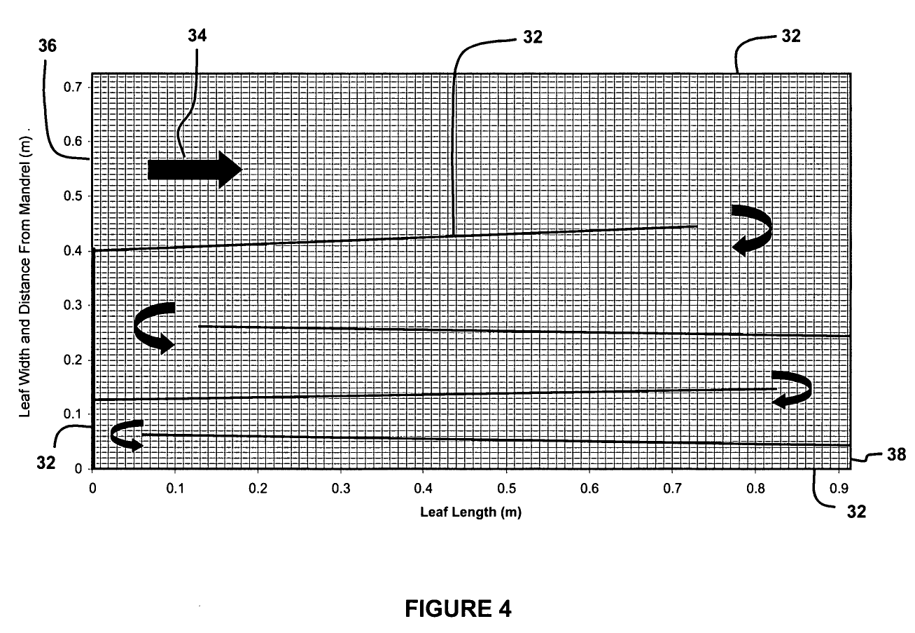

The width of successive stages may decline towards the membrane area outlet 38. This allows for a generally constant or increasing feed side velocity towards the membrane area outlet 38 which is useful to help counter the increased fouling potential of the feed as it is concentrated towards the membrane area outlet. In the example of FIG. 3, the membrane area outlet 38 has a width and cross-sectional area of 15% of the membrane area inlet 36. Another embodiment shown in FIG. 4 is intended to modify a Filmtec 8040 module having NF-270 membranes. In this embodiment, the width and cross sectional area of the flow path 34 decreases both within the stages and between successive stages so that feed side velocity throughout the module 6 is more constant or more constantly increasing. Also, the membrane area outlet 38 has about 12% of the width and cross sectional area of the membrane area inlet 36. In this module, at a design recovery of 85% and concentrate flow of 2.8 L/min, feed side velocity generally increases along the feed path 34 although there may be individual stages, such as stage 1, in which feed velocity decreases along the feed path 34. In particular, the concentrate exit velocity (0.22 ft/s) across the membrane area outlet 38 is about 29% more than the average velocity in the first stage (0.17 ft/s).

To make a spacer 30 with dams 32, the following procedure can be used:

1. Cut plastic sheets to dimensions slightly larger than the spacer 30 and place one on a hard flat surface.

2. On the plastic sheet outline the dam or baffle 32 with a market.

3. Place overlapping sheets of wax paper on the plastic sheet to cover the area.

4. Position a spacer 30 on the wax paper and tack at edges with masking tape to keep flat and prevent it from moving during silicone application.

5. Using a cartridge caulking gun loaded with a silicone sealant (i.e. General Electric Silicone II), carefully place a bead of sealant along the marked lines.

6. Place overlapping sheets of wax paper over the spacer 30 and sealant.

7. Place the second plastic sheet on the wax paper and press firmly to flatten the silicone bead into the spacer 30.

8. With wax paper attached, remove spacer 30 to curing area.

9. Repeat steps 3 to 8 for as many spacers 30 as required.

10. Allow at least 48 hours for the silicone sealant to cure before use.

Alternate methods may also be used. For example other sealant materials, a thermoplastic material or resin may be used is used to build dams 32 on either the spacer or the membrane sheet. Dams 32 made of silicone or solid plastic may be secured to the leaves and then spacer material 30 cut to fit within the dams 32. For further example, solid, preferably elastic or elastomeric, strips can be glued to both sides of a spacer 30. When the module 6 is rolled up, the strips compress into the spacer 30 and create dams 32. Or the dams 32 may be incorporated in a spacer mold for extrusion as a spacer suitable for this application.

A typical module 6 may have 2 or more leaves. While the leaves are generally all of the same membrane material or chemistry, modules 6 may also be made with leaves of varying chemistry. For example, a module may be made with 3 leaves of Filmtec NF-90 and 3 leaves of Filmtec NF-270. The NF-90 leaves have about 99% hardness rejection while the NF-270 leaves have about 50-70% hardness rejection. However, the NF-270 leaves provides a greater flux, the other provides greater rejection. By mixing these or other materials, a module having flux and rejection characteristics between those of the two or more leaf materials used can be made without developing a new material. In the example above, a hardness rejection of over 70% can be achieved with flux greater than that of an NF-90 module. Further one or more leaves of special materials, such as Filmtec XLE which for example rejects arsenic to a greater degree than NF-90 or NF-270, may be added to provide some rejection of selected materials without having the characteristics of a module 6 made entirely of the special material.

Process Steps and Parameters

The systems described in FIGS. 1 and 2 are useful, for example, as point-of-entry nanofiltration systems for home use having the capability of removing at least 30%, for example 50 to 80%, or more of hardness while eliminating all pathogens. The permeate may also have lower concentrations of total solids, calcium, magnesium, sodium, heavy metals, and alkalinity than the feed. The description below provides further details of the operation of such systems for that use but may also apply to other uses of the same or similar systems, for example a desalination system.

During permeation, TMP may be in the range of 100 to 110 psi for a nanofiltration system. With permeate stored in a pressure tank at typical values for household use of 30 to 60 psi, total feed pressure may be 130 to 200 psi. Velocity through the feed side and the number of stages is chosen so that the pressure drop through the feed/concentrate side of the module 6 does not exceed the design limits of the module 6. For example, where commercially available nanofiltration modules are used, with modifications as described above, the maximum feed side pressure drop, which is often 15 psi, remains applicable. Pressure drops of 10 psi or less or 5 psi or less are preferred. However, for reverse osmosis systems, one or more of the pressures above are likely to be higher. For example, feed pressure may be up to 400 psi in a system as in FIGS. 1 and 2 having an RO module. Conversely, some pressures for an ultrafiltration system may be less than for a nanofiltration system.

Velocities through the feed/concentrate side of the module 6 may be in the range of 0.05 to 0.4 feet per second. The spacer 30 provides turbulence and allows operation at these speeds without excessive fouling due to deposition of calcium carbonate scale and other impurities and without the need for external (to the module 6) turbulence creating equipment. At velocities below 0.05 feet per second there is not enough flow or turbulence to prevent excessive fouling at the desired single pass recovery rates of 70% or more. While higher velocities are generally more desirable, higher velocities also require more stages to meet the other system requirements. For example, a module 6 with feed/concentrate velocities generally between 0.15 and 0.25 feet per second requires 5 stages. To increase feed/concentrate velocities to 0.4 feet per second requires 7 or 9 stages. This is about the highest number of stages possible to achieve single pass recoveries of 70% or more without exceeding the maximum feed/concentrate side pressure loss of a typical nanofiltration module 6.

Flux, fouling rate and rejection are interrelated parameters. Feed side velocity, particularly the exit velocity of the feed/concentrate at the membrane area outlet 38 where concentration levels are highest, is also relevant to fouling and is controlled both by operation of the system and by configuration of the dams 32. The system of FIG. 2 is intended for a low usage application, such as a home, where simplicity and cost are critical factors. The manual cleaning process is intended to be used only infrequently, for example once or twice a year, or less. The system of FIG. 1 is intended for more demanding use where a more complex system is justified. Smaller cleaning events are performed more often, for example from once a day to once a month.

For example a 3 stage module of Filmtec NF-270 membrane material was run as in a FIG. 1 system under three operating conditions all using an exit velocity of 0.12 ft's. The first condition was flux of 30 μm²/h and a recovery of 72% which resulted in a conductivity rejection, which is less than the hardness rejection, of 55%. The second condition was a flux of 45 μm²/h and a recovery of 80% which resulted in an average conductivity rejection of 65%. A third condition had a flux of 60 μm²/h and a recovery of 84% which resulted in an average conductivity rejection of 61%. In all three cases, cleaning with MC-1 was provided after every 24 hours of continuous operation which, for a typical household, would have provided enough water for 1 to 2 weeks of operation. No significant decreases in permeability were detected over more than 10 days of continuous operation at each condition indicating that any losses in flux between cleaning events were essentially recoverable and that continuous operation at essentially full membrane permeability can be achieved.

In another example, another module of NF-270 membrane material was run without chemical cleaning, and with a feed of well water, to determine the exit velocity under which the fouling rate would be sufficiently low so that chemical cleaning would not be required for over a year of operation at the point of entry of a typical North American household. At a recovery of 80%, an exit velocity of 0.05 feet per second is required. At a recovery of 85%, an exit velocity of 0.11 feet per second is required. At a recovery of 90%, an exit velocity of 0.26 feet per second is required.

As an example design, the system of FIG. 2 may be used with a module as discussed in relation to FIG. 4. Feed pressure may be 130 to 160 psi, to give a TMP of about 100 psi. Design permeability may range from 7.5 to 3 L/m²/h/bar depending on temperature. Design flux may range from 52 to 21 L/m²/h or 32 to 13 L/min. Recovery may vary from 92% to 70%. Exit velocity may range from about 0.23 to 0.17 ft/s. Expected feed temperature range is 10-25° C. Despite the large effect of feed temperature on permeability, calcium carbonate is more soluble at lower temperatures. This allows operation at a velocity near the bottom of the range given above while giving acceptable recovery when operating at lower temperatures. With this system and process, operation can be continued for 6 to 12 months or more before cleaning is required.

In using well water feeds, the inventors further noticed that fresh well water typically has a very low dissolved oxygen concentration or oxygen reduction potential (ORP) but that fouling rates decrease at higher ORPs. Accordingly, filtration of well water can be improved by exposing well water to air, for example for 1 to 24 hours, optionally with agitation or bubbling air through it to reduce the required contact time, increase its ORP before filtering it. It was further observed that permeability decreases more rapidly under continuous operation than intermittent operation. For example, permeating for 15 minute periods and providing 45 minutes between permeation periods noticeably decreased the rate of fouling over continuous operation. Accordingly, it is desirable for the module 6 and holding tank 10 to be sized to provide a day's worth of product in 6 hours or less, preferably 3 hours or less, of permeation time and for that permeation time to occur in periods of between 2 minutes to 30 minutes separated by relaxation periods of 1 hour to 12 hours.

For cleaning, MC-1 or other chemicals may be used as the cleaning chemical. Some chemicals, including citric acid, diffuse through typical membranes and so it is necessary to rinse the permeate side of the system of any residual chemical before returning to permeation. In one example system with a volume of 5 L, 30 L of permeate flow was sufficient to essentially eliminate the cleaning chemical from the permeate side. In other systems, other amounts of permeate flow may be required.

### FURTHER EXAMPLES

### Example #1

### Long-Term Operation with Daily Cleaning

Experimental Conditions:

Feed Source: Raw ZENON Well Water

Total Hardness (Feed)=400 mg/L (as CaCO₃)

Permeation Rate=9-12 L/min

Flux=20-28 Lmh

Recovery=80-90%

Exit Velocity=0.0381-0.0606 m/s

Temperature=20-26° C.

Cleaning Frequency=2.7 hrs (one equivalent day of home use)

Initial Permeability=8.2 Lmh/bar

Final Permeability=7.0 Lmh/bar

Feed/concentrate velocity=0.125-0.19 ft/s

These modules A, B, C, were arranged in series with A upstream of B and B upstream of C. Together, these modules have 8 stages.

Membrane Specifications:

| | | | Modified | |
|---|---|---|---|---|
| | | | To Have # | |
| | Original | | of Internal | Surface Area |
| Module | Manufacturer | Chemistry | Stages | (m²) |
| Element A | Dow -FilmTech | NF-270/4040 | 1 | 7.618 |
| Element B | Dow -FilmTech | NF-270/4040 | 3 | 7.455 |
| Element C | Dow -FilmTech | NF-270/4040 | 5 | 7.037 |

This demonstrates that over a 2 months and 9 days of operation (equivalent to an entire year of water supply to a single house) at recoveries of 80-90%, the permeability dropped only 15%, demonstrating system performance under field conditions.

### Example #2

### Membrane Cleaning Cycle

Cleaning Cycle involves 3 stages of operation:

1. Flush (4.5 min)—cleaning chemical is dosed into feed stream via an eductor (Mazzei Injector Corp. Model# 384). Concentrated MC-1 90 g/L is injected and diluted to bring the feed pH down to 2.8.

2. Soak (60 min)—flow is stopped. Chemical is held within the membrane elements for 1 hour.

3. Rinse (5 min)—feed is reintroduced (without chemical injection) and all effluent is sent to the drain for the entire rinse time to remove MC-1 from the system.

Permeability of membranes increases after each cleaning cycle and decreases in between cleaning cycles as the membranes foul. Cleaning frequencies of 2.7 hrs (one equivalent day of home use), 9 hrs, 18 hrs and 23 hrs (equivalent to 8.5 days of home use) were used with results showing full recovery of permeability in each case (see FIG. 3).

### Example 3

A FilmTech NF-270/4040 module modified to have 3 internal stages was run at a flux of 76 Lmh to test the effect of process conditions on permeate quality.

Experimental Conditions:

Feed Source: Raw ZENON Well Water

Total Hardness (Feed)=400 mg/L (as CaCO₃)

Feed Flow=10.45 L/min

Permeation rate=9.4 L/min

Flux=76 Lmh

Recovery=90%

Transmembrane Pressure=890 kPa

Temperature=32° C.

Feed/concentrate side velocity=0.08-0.328 ft/s

Permeate quality and rejection were as follows:

Permeate total hardness: 144 mg/L (as CaCO₃)

Total hardness rejection: 64.7%

This demonstrates that the system achieves substantial improvement in permeate quality over feed under preferred operating conditions.

The embodiments above are exemplary only. Modified or other apparatuses and processes may also be made within the scope of the invention protected by this patent which is defined by the following claims.

We claim:

1. A process comprising the steps of,
a) providing a multi-stage spiral wound hardness rejecting module of membranes having a feed/concentrate side and a permeate side;
b) flowing pressurized feed water through the feed/concentrate side of the module in a single pass, the feed water having a superficial velocity of between 0.05 and 0.4 feet per second over the last portion of membranes on the feed/concentrate side of the module; and,
c) collecting at least 70% of the feed water as permeate from the permeate side of the module.

2. The process of claim 1 wherein between 80% and 95% of the feed water is collected as permeate.

3. The process of claim 1 wherein the module is a 40″ length module having a permeability of less than about 0.6 gfd/psi.

4. The process of claim 1 wherein the permeate has at least 30% less hardness than the feed water.

5. The process of claim 1 wherein the minimum feed side superficial velocity is in the range of 0.05 ft's to 0.4 ft/s.

6. The process of claim 5 wherein either the minimum superficial feed side velocity or exit superficial velocity is in the range of 0.12 ft/s to 0.3 ft/s.

7. The process of claim 1 wherein the feed water is taken from a well and contacted with air to increase its dissolved oxygen content before flowing it to the module.

8. The process of claim 1 wherein the permeate is collected in a holding tank and the step of flowing pressurized feed water begins when the pressure or water level of the permeate in the holding tank reaches a selected limit.

9. The process of claim 8 wherein the step of flowing pressurized feed water is stopped when the level or pressure of permeate in the holding tank reaches a selected limit.

10. The process of claim 1 further comprising the steps of,
a) flowing water containing cleaning chemical to the feed/concentrate side of the module;
b) holding the cleaning chemical in the feed/concentrate side module for a reaction time;
c) discharging the cleaning chemical from the feed/concentrate and permeate sides of the module.

11. The process of claim 10 wherein the steps of claim 10 are started when the permeability of the membranes reaches a selected limit or at selected time intervals.

12. The process of claim 10 wherein the cleaning chemical is provided by mixing cleaning chemical into feed water flowing into the module.

13. The process of claim 10 wherein the cleaning chemical is provided in a flow of liquid into a concentrate outlet of the module.

14. The process of claim 10 wherein the cleaning chemical flows into the feed/concentrate side of the module by gravity induced flow.

15. The process of claim 1 wherein the permeate side of the module has no inlet from outside of the module.

16. The process of claim 1 wherein the holding tank has a pressure above ambient adapted to supply permeate to a user without further pressurization.

17. The process of claim 1 wherein the membrane material rejects salt.

18. The process of claim 1 wherein the module has multiple stages on its feed side.

19. The process of claim 18 wherein the module has a membrane area exit and a first stage and the velocity of feed or concentrate over the membrane area exit is a factor of 1.2 or more times the velocity of feed or concentrate in the first stage.

20. The process of claim 1 wherein pressure drop through the feed side is 10 psi or less.

21. The process of claim 1 wherein the dissolved oxygen content of the feed water is increased upstream of the membrane module.

22. The process of claim 1 wherein permeation is performed intermittently.

23. A spiral wound RO, NF or UF module adapted for use in liquid filtration and having one or more leaves of membrane material wrapped around a mandrel and mounted in a shell, having the shell side of the membrane material as the feed side, having spacer material on the feed side between adjacent leaves or parts of a leaf, and the feed path having multiple passes through the spacer material and across the outer surfaces of the leaf or leaves of the module.

24. The module of claim 23 wherein the feed side flow path has an entrance to the outer surfaces of the leaf or leaves and an exit from the outer surfaces of the leaf or leaves and the width or cross-sectional area of the exit is 20% or less than that of the entrance.

25. The module of claim 24 wherein the width or cross-sectional area of the exit is 15% or less than that of the entrance.

26. The module of claim 23 wherein the passes are generally parallel to the mandrel.

27. The module of claim 26 wherein the first pass is more distant from the mandrel than the last pass.

28. The module of claim 23 having multiple leaves, at least one leaf having a different membrane material or chemistry than another leaf.

29. The module of claim 23 wherein the membranes have a hardness rejection of 50% or more.

30. The module of claim 23 module having 3 to 9 stages in the feed/concentrate side.

31. The module of claim 30 wherein each stage decreases in width or cross-sectional area along a flow path.

32. The module of claim 30 wherein each successive stage is reduced in cross-sectional area or width compared to a preceding stage.

33. The module of claim 23 wherein the module has a standard 40″ length.

34. An apparatus comprising,
a) a membrane module contained in a shell with a feed/concentrate side into where feed water enters and from where concentrate exits, and a permeate side from where treated water exits, wherein the feed/concentrate side is configured to provide multiple flow passes;
b) a feed pump connected to the feed/concentrate side of the module;
c) a conduit or passage for concentrate to flow from the module to drain or another apparatus;
d) an inlet for feed to enter the feed pump; and,
e) an outlet for permeate to exit the module.

35. The apparatus of claim 34 further comprising,
a) a tank for storing a cleaning chemical,
b) conduits and valves to facilitate feeding the cleaning chemical to the module from time to time; and,
c) conduits and valves to facilitate discharging chemically contaminated permeate from the module.

36. The apparatus of claim 35 further comprising a venturi in a feed line to the module adapted to introduce cleaning chemical from the tank to feed flowing to the module.

37. The apparatus of claim 35 wherein the tank is located above the module and the conduits and valves are adapted to facilitate flowing cleaning chemical from the tank through the module by gravity flow.

38. A process comprising the steps of:
a) providing a spiral wound UF module having a feed/concentrate side and a permeate side;
b) flowing pressurized feed water through the feed/concentrate side of the module in a single pass, the feed water having a superficial velocity of between 0.05 and 0.4 feet per second over the last portion of membranes on the feed/concentrate side of the module; and,
c) collecting at least 70% of the feed water as permeate from the permeate side of the module.

39. The process of claim 38 wherein between 80% and 95% of the feed water is collected as permeate.

40. The process of claim 38 wherein the module has a permeability of about 0.6 gfd/psi or more.

41. The process of claim 39 wherein the module has a permeability of about 0.6 gfd/psi or more.

42. The process of claim 38 wherein the minimum feed side superficial velocity is in the range of 0.05 ft/s to 0.4 ft/s.

43. The process of claim 42 wherein either the minimum superficial feed side velocity or exit superficial velocity is in the range of 0.12 ft/s to 0.3 ft/s.

44. The process of claim 38 wherein the feed water is taken from a well and contacted with air to increase its dissolved oxygen content before flowing it to the module.

45. The process of claim 38 wherein the permeate is collected in a holding tank and the step of flowing pressurized feed water begins when the pressure or water level of the permeate in the holding tank reaches a selected limit.

46. The process of claim 45 wherein the step of flowing pressurized feed water is stopped when the level or pressure of permeate in the holding tank reaches a selected limit.

47. The process of claim 38 further comprising the steps of,
a) flowing water containing cleaning chemical to the feed/concentrate side of the module;
b) holding the cleaning chemical in the feed/concentrate side module for a reaction time;
c) discharging the cleaning chemical from the feed/concentrate and permeate sides of the module.

48. The process of claim 47 wherein the steps of claim 47 are started when the permeability of the membranes reaches a selected limit or at selected time intervals.

49. The process of claim 47 wherein the cleaning chemical is provided by mixing cleaning chemical into feed water flowing into the module.

50. The process of claim 47 wherein the cleaning chemical is provided in a flow of liquid into a concentrate outlet of the module.

51. The process of claim 47 wherein the cleaning chemical flows into the feed/concentrate side of the module by gravity induced flow.

52. The process of claim 38 wherein the permeate side of the module has no inlet from outside of the module.

53. The process of claim 38 wherein the holding tank has a pressure above ambient adapted to supply permeate to a user without further pressurization.

54. The process of claim 38 wherein the module has multiple stages on its feed side.

55. The process of claim 54 wherein the module has a membrane area exit and a first stage and the velocity of feed or concentrate over the membrane area exit is a factor of 1.2 or more times the velocity of feed or concentrate in the first stage.

56. The process of claim 38 wherein pressure drop through the feed side is 10 psi or less.

57. The process of claim 38 wherein the dissolved oxygen content of the feed water is increased upstream of the membrane module.

58. The process of claim 38 wherein permeation is performed intermittently.
